(19) United States
(12) Patent Application Publication
(10) Pub. No.: US 2022/0319192 A1
(43) Pub. Date: Oct. 6, 2022

(54) DRIVING ASSISTANCE DEVICE, DRIVING ASSISTANCE METHOD, AND NON-TRANSITORY COMPUTER-READABLE MEDIUM

(71) Applicant: PANASONIC INTELLECTUAL PROPERTY MANAGEMENT CO., LTD., Osaka (JP)

(72) Inventors: Noriyuki TANI, Kanagawa (JP); Yuya MATSUMOTO, Tokyo (JP); Shota AKAURA, Kanagawa (JP)

(73) Assignee: PANASONIC INTELLECTUAL PROPERTY MANAGEMENT CO., LTD., Osaka (JP)

(21) Appl. No.: 17/847,690

(22) Filed: Jun. 23, 2022

Related U.S. Application Data
(63) Continuation of application No. PCT/JP2020/036877, filed on Sep. 29, 2020.

(30) Foreign Application Priority Data
Dec. 25, 2019 (JP) 2019-235099

(51) Int. Cl. G06V 20/58; B60W 50/14

(52) U.S. Cl. CPC G06V 20/58; B60W 50/14; B60W 2420/42; B60W 2554/4049; B60W 2050/146

(57) ABSTRACT

A driving assistance device for assisting driving of a moving body, the driving assistance device includes: a processor; and a memory storing instructions that, when executed by the processor, cause the driving assistance device to perform operations. The operations include: acquiring a self-produced image obtained by capturing an image of a surrounding of a moving body by a first image capturing device mounted on the moving body and an other-produced image captured by a second image capturing device different from the first image capturing device; and generating a visible composite image by compositing a plurality of images including the self-produced image and the other-produced image.

### CROSS-REFERENCE TO RELATED APPLICATIONS

This is a continuation of International Application No. PCT/JP2020/036877 filed on Sep. 29, 2020, and claims priority from Japanese Patent Application No. 2019-235099 filed on Dec. 25, 2019, the entire content of which is incorporated herein by reference.

### TECHNICAL FIELD

The present disclosure relates to a driving assistance device, a driving assistance method, and a program for assisting driving.

### BACKGROUND ART

In the related art, in a vehicle such as an automobile, there is known a device that displays an image in which captured images of a plurality of vehicle-mounted cameras included in a host vehicle are merged into one image so that an entire region captured by the plurality of vehicle-mounted cameras can be seen, instead of displaying the images independently of each other (for example, see JP-B2-3286306).

### SUMMARY OF INVENTION

The present disclosure provides a driving assistance device for assisting driving of a moving body, the driving assistance device including: a processor; and a memory storing instructions that, when executed by the processor, cause the driving assistance device to perform operations including: acquiring a self-produced image obtained by capturing an image of a surrounding of a moving body by a first image capturing device mounted on the moving body and an other-produced image captured by a second image capturing device different from the first image capturing device; and generating a visible composite image by compositing a plurality of images including the self-produced image and the other-produced image.

The present disclosure provides a driving assistance method in a driving assistance device for assisting driving of a moving body, the driving assistance method including: acquiring a self-produced image obtained by capturing an image of a surrounding of a moving body by a first image capturing device mounted on the moving body and an other-produced image captured by a second image capturing device different from the first image capturing device; and generating a visible composite image by compositing a plurality of images including the self-produced image and the other-produced image.

The present disclosure provides a non-transitory computer-readable medium storing a program that, when executed by a processor, causes a computer to execute a driving assistance method for assisting driving of a moving body, the driving assistance method including: acquiring a self-produced image obtained by capturing an image of a surrounding of a moving body by a first image capturing device mounted on the moving body and an other-produced image captured by a second image capturing device different from the first image capturing device; and generating a visible composite image by compositing a plurality of images including the self-produced image and the other-produced image.

### BRIEF DESCRIPTION OF DRAWINGS

FIG. 1 is a block diagram showing an example of a configuration of a driving assistance device according to an embodiment.

FIG. 2 is a diagram showing an example of a positional relationship between a host vehicle and another vehicle and a composition image according to a first embodiment.

FIG. 3 is a diagram showing an example of a positional relationship between a host vehicle and another vehicle and a composition image according to a second embodiment.

FIG. 4 is a diagram showing an example of a positional relationship between a host vehicle and another vehicle and a composition image according to a third embodiment.

FIG. 5 is a diagram showing an example of a positional relationship between a host vehicle and another vehicle and a composition image according to a fourth embodiment.

FIG. 6 is a diagram showing an example of a positional relationship between a host vehicle and another vehicle and a composition image according to a fifth embodiment.

FIG. 7 is a flowchart showing an example of generation processing of a visible composite image.

FIG. 8 is a sequence diagram showing a first example of an image acquisition operation of acquiring a captured image of an other-produced image.

FIG. 9 is a sequence diagram showing a second example of an image acquisition operation of acquiring a captured image of an other-produced image.

### DESCRIPTION OF EMBODIMENTS

### Introduction to Present Disclosure

As described above, when driving assistance is performed using a captured image captured by a camera mounted on a moving body such as a vehicle, generation of an appropriate image according to an operation state of the moving body, a surrounding state, and the like is required.

In the related art described in JP-B2-3286306, it is possible to composite captured images of the surroundings of the vehicle captured by cameras provided at a plurality of locations (for example, four locations of front, rear, left, and right) of the host vehicle, and to generate and display a bird's-eye view image as viewed from, for example, above the vehicle.

However, in the related art described above, there is a problem that only a composite image in a range that can be captured by a vehicle-mounted camera included in the host vehicle is obtained, and a user cannot recognize an image in a region outside an image capturing range of the host vehicle. The region outside the image capturing range of the host vehicle includes, for example, a region that becomes a blind spot due to a blocking object such as an obstacle and cannot be captured, and a region outside the image capturing range of the vehicle-mounted camera based on performance of the vehicle-mounted camera or an angle of view of the vehicle-mounted camera.

Therefore, in the present disclosure, a configuration example of a driving assistance device is shown in which an appropriate image according to the operation state, the surrounding state, or the like of the moving body can be generated and the driving assistance can be performed, and the user can also confirm a region outside the image capturing range of the camera mounted on the moving body such as the vehicle.

Hereinafter, embodiments specifically disclosing a driving assistance device, a driving assistance method, and a program according to the present disclosure will be described in detail with reference to the accompanying drawings as appropriate. However, unnecessarily detailed descriptions may be omitted. For example, a detailed description of a well-known matter or a repeated description of substantially the same configuration may be omitted. This is to avoid unnecessary redundancy in the following description and to facilitate understanding of those skilled in the art. Note that the accompanying drawings and the following description are provided to provide a thorough understanding of the present disclosure for those skilled in the art, and are not intended to limit the subject matter recited in the claims.

### CONFIGURATION OF EMBODIMENT

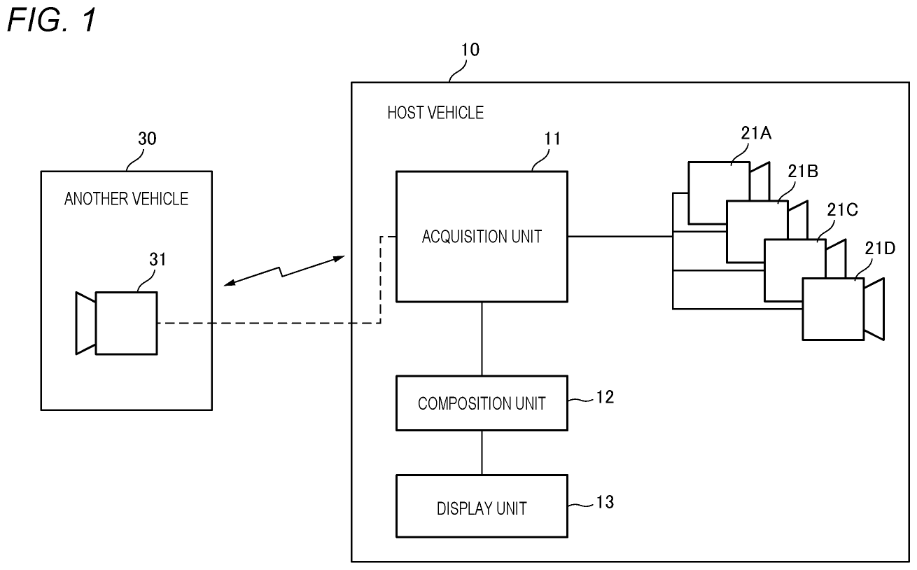

FIG. 1 is a block diagram showing an example of a configuration of a driving assistance device according to an embodiment. In the present embodiment, a configuration example will be described in which an image including a situation surrounding a vehicle is captured by a camera mounted on a vehicle as an example of a moving body, and image composition is performed using the captured image.

A host vehicle 10 serving as a first vehicle is a vehicle on which a user himself/herself rides and drives or rides together, and corresponds to a moving body of the user himself/herself. The host vehicle 10 includes cameras 21A, 21B, 21C, and 21D as image capturing units that capture an image of a surrounding situation of the host vehicle. The plurality of cameras 21A, 21B, 21C, and 21D are mounted on, for example, front, rear, left, and right vehicle bodies of the vehicle, and cover a region in an entire circumferential direction of an outer periphery of the vehicle as an image capturing range.

The host vehicle 10 includes an acquisition unit 11 that receives and acquires a captured image, a composition unit 12 that performs image composition processing as a processing unit that performs processing of the acquired captured image, and a display unit 13 that displays a composite image. The acquisition unit 11 has an interface having a communication function such as a camera interface or a communication interface, and acquires captured images (self-produced images) captured by the plurality of cameras 21A, 21B, 21C, and 21D of the host vehicle and captured images (other-produced images) captured by other image capturing units by the communication function of the interfaces.

The composition unit 12 includes a processing device including a processor and a memory, and implements various functions, for example, by a processor executing a predetermined program held in the memory. The composition unit 12 performs composition processing of the plurality of captured images acquired by the acquisition unit 11, and generates a visible composite image. The processor may include a micro processing unit (MPU), a central processing unit (CPU), a digital signal processor (DSP), a graphical processing unit (GPU), and the like. The memory may include a random access memory (RAM), a read only memory (ROM), and the like. The storage may include a hard disk drive (HDD), a solid state drive (SSD), an optical disk device, a memory card, and the like.

The composition unit 12 outputs the visible composite image generated by the composition processing to the display unit 13 and provides the visible composite image to the display unit 13, and causes the visible composite image to be displayed on the display unit 13.

The display unit 13 displays the visible composite image related to the surrounding situation of the host vehicle generated by the composition unit 12. The display unit 13 is implemented by various display devices such as a display device that is mounted on a front portion of a vehicle such as an augmented reality head up display (AR-HUD) or an HUD and projects and displays on a front window, an organic EL display mounted on a dash panel or the like of the vehicle, and a display device such as a liquid crystal display.

Another vehicle 30 as a second vehicle is a vehicle other than the host vehicle, for example, a vehicle traveling or stopping near the host vehicle 10, and corresponds to another moving body. The another vehicle 30 includes a camera 31 as an image capturing unit that captures an image of a surrounding situation of the another vehicle 30. The number of cameras 31 may be one or more. The camera 31 is mounted on, for example, the vehicle body of the vehicle, and covers a part of the outer periphery of the vehicle or a region in the entire circumference direction as an image capturing range. The another vehicle 30 communicates with the acquisition unit 11 of the host vehicle 10, transmits a captured image captured by the camera 31, and provides the captured image as an other-produced image. The image capturing unit that captures the other-produced image is not limited to the camera 31 of the another vehicle 30, and may be an image capturing unit mounted on a related facility installed on a road or a parking lot on which the host vehicle 10 as the first vehicle travels. For example, cameras provided at various positions other than the host vehicle, such as an infrastructure camera installed at an intersection of a road, a side of a road, or an elevated road, a camera installed in a building along the road, and a camera installed in a parking lot, may be used.

Image transmission between the acquisition unit 11 and the camera 31 of the another vehicle 30 can be implemented using a high-speed communication system having a predetermined communication band, such as vehicle to vehicle (VtoV) communication or 5G mobile communication. When the infrastructure camera is used as the image capturing unit that captures the other-produced image, various communication systems such as a vehicle to infrastructure (VtoI) communication and a vehicle to X (VtoX) communication can be used in accordance with a system configuration of the driving assistance device, for example, when another camera is used.

In the host vehicle 10, the acquisition unit 11 acquires a captured image of the self-produced image captured by the cameras 21A, 21B, 21C, and 21D of the host vehicle 10. In a scene satisfying a predetermined condition, the acquisition unit 11 acquires a captured image of an other-produced image captured by the camera 31 of the another vehicle 30 or another image capturing unit. The composition unit 12 performs composition processing on the captured image of the self-produced image acquired by the host vehicle 10. The composition unit 12 composites the captured image of the other-produced image acquired from the another vehicle 30 or another image capturing unit with the self-produced image. The composition unit 12 generates, for example, a bird's-eye view image looking down from above an image capturing region including the host vehicle 10 as a visible composite image after the composition processing. In addition to the bird's-eye view image, various composite images such as a panoramic image of the entire circumference of 360 degrees or a surrounding of a predetermined angle range of the host vehicle 10 and a bird's-eye view image viewed from a predetermined viewpoint position may be generated, or a composite image in which a plurality of types of images such as the bird's-eye view image and the panoramic image of a front viewing angle range are composited may be generated.

The display unit 13 displays the visible composite image generated by the composition unit 12. When an AR-HUD is provided in the front window of the host vehicle 10 as the display unit 13, the visible composite image is displayed in the front window by the AR-HUD, and is superimposed on a real image of a field of view in front of the vehicle, which is seen through the front window from the viewpoint of the user. When the display device is provided on the dash panel or the like of the vehicle as the display unit 13, the visible composite image is displayed on the display device, and an image indicating a surrounding situation including a captured image outside the host vehicle is presented to the user. As the display unit 13, another human machine interface (HMI) may be used.

In addition to the display unit 13, the host vehicle 10 may include a notification unit that notifies the user by sound, light, or the like. The composition unit 12 or the display unit 13 transmits notification information to the notification unit when the surrounding situation becomes a predetermined state, and causes the notification unit to notify the user of the predetermined surrounding situation. The notification unit notifies the user of the presence of a predetermined object by a notification sound, lighting, or the like when there is a predetermined object to be noted such as a vehicle, a person, or the like outside the image capturing range of the host vehicle 10 based on the visible composite image generated by the composition unit 12. In addition, the display unit 13 may include a function of the notification unit, and in the display of the visible composite image, a region corresponding to a case where the predetermined object to be noted such as another vehicle, a person, or the like is present in the image may be highlighted, a specific color display, an illustration display, or the like may be distinctively displayed, so that the user can easily recognize the region. In the display of the visible composite image on the display unit 13, the display of the host vehicle can be easily identified by performing a distinguishing display such as the specific color display or the illustration display.

The driving assistance device according to the present embodiment includes the acquisition unit 11 and the composition unit 12 in the host vehicle 10. At least one of the acquisition unit 11 and the composition unit 12 may be provided outside the host vehicle 10. The driving assistance device may include the display unit 13 that displays the visible composite image. The driving assistance device may include the notification unit that notifies that the surrounding situation is in a predetermined state, for example, when the predetermined object is present in the image of the visible composite image.

Hereinafter, as embodiments of the present disclosure, some operation states of a scene (scene examples) in which a composite image including a self-produced image and an other-produced image is generated will be exemplified.

### First Embodiment

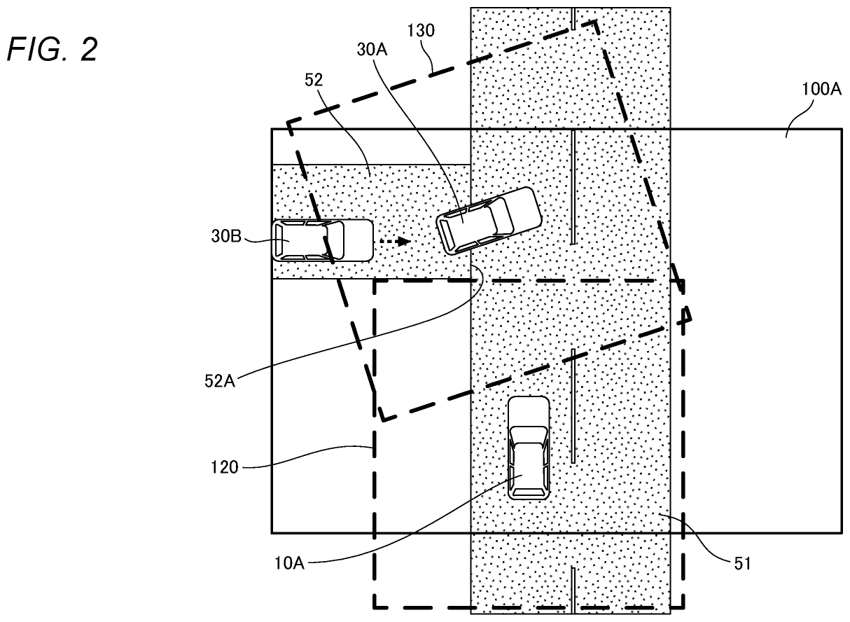

FIG. 2 is a diagram showing an example of a positional relationship between a host vehicle and another vehicle and a composite image according to a first embodiment. The first embodiment shows an example of generation of a composite image in a scene (a scene of an intersection) in which the host vehicle is traveling on an intersection with poor visibility or a road heading for an entrance from a side road, as a situation of the host vehicle corresponding to a scene satisfying a predetermined condition.

In the scene of the first embodiment, a first vehicle 10A, which is the host vehicle, is traveling on a main road 51 having a large width. In front of the first vehicle 10A, there is an entrance 52A of a side road 52 connected to the main road 51, which is an intersection with poor visibility. A second vehicle 30A, which is another vehicle, enters the side road 52, and a third vehicle 30B, which is another vehicle following the second vehicle 30A, travels behind the second vehicle 30A. In this case, a part of the second vehicle 30A and the entirety of the third vehicle 30B become blind spots from the first vehicle 10A due to walls, fences, and the like of buildings at road edges, and are out of the image capturing range that is out of an image capturing range 120 of the camera of the first vehicle 10A. Therefore, it is difficult for the first vehicle 10A to capture an image of the third vehicle 30B, the captured image of the first vehicle 10A does not include the third vehicle 30B, and the third vehicle 30B following the second vehicle 30A cannot be recognized in the first vehicle 10A. On the other hand, an image capturing range 130 of the camera of the second vehicle 30A includes the third vehicle 30B together with the second vehicle 30A, and an image of the third vehicle 30B can be captured from the second vehicle 30A. Therefore, the third vehicle 30B is included in the captured image of the second vehicle 30A.

In the present embodiment, when a traveling direction of the first vehicle 10A and the traveling direction of the second vehicle 30A intersect with each other, in the first vehicle 10A, an other-produced image captured by the second vehicle 30A is acquired, and a composite image 100A is generated using the self-produced image captured by the host vehicle and the acquired other-produced image. The third vehicle 30B may be used as the another vehicle instead of the second vehicle 30A, and the other-produced image captured by the third vehicle 30B may be acquired from the third vehicle 30B and composited. Communication such as image transmission between the first vehicle 10A and the second vehicle 30A or the third vehicle 30B may be VtoV communication, 5G mobile communication, network communication of a computer network using a wireless LAN or the like, or the like. The transmission of the captured image may be performed by requesting the captured image from the first vehicle 10A to the second vehicle 30A or the third vehicle 30B and acquiring the captured image as the other-produced image when the another vehicle entering in front of the host vehicle in the traveling direction is recognized, or may be performed by transmitting the captured image from the second vehicle 30A or the third vehicle 30B to the nearby first vehicle 10A when the another vehicle enters the intersection. When the first vehicle 10A, the second vehicle 30A, and the third vehicle 30B attempt to communicate with the surroundings at a predetermined timing and can communicate with each other, the first vehicle 10A, the second vehicle 30A, and the third vehicle 30B may hold, as status information, information indicating that a connectable vehicle is present nearby the host vehicle, and transmit and receive image data and the like. The captured images may be composited not only with the host vehicle and a single another vehicle, but also with the host vehicle and a plurality of other vehicles, and images acquired in any of the plurality of vehicles may be composited.

In the example of FIG. 2, the composite image 100A of the bird's-eye view image viewed from above the host vehicle is shown. In the composite image 100A, the first vehicle 10A of the host vehicle is displayed at, for example, a lower center position. The composite image 100A includes an image of the second vehicle 30A entering the main road 51 from the side road 52 and an image of the following third vehicle 30B, and an occupant (driver, fellow passenger) of the first vehicle 10A can recognize an object such as a vehicle or a person in a region that cannot be captured by the host vehicle. Accordingly, it is possible for the host vehicle to confirm the approach of the another vehicle from the outside of the image capturing range. In the shown example, images captured by the following third vehicle outside the image capturing range are composited and displayed, and the presence of the vehicle or the like that cannot be captured from the host vehicle can be recognized at an early stage.

When the AR-HUD is used as the display unit, a visible composite image is superimposed and displayed on the front window of the host vehicle by an augmented reality (AR) technique. Accordingly, the third vehicle following the second vehicle and approaching from the blind spot outside the image capturing range can be displayed in the visible composite image, and the user can recognize the approach of the third vehicle together with a real image of the field of view while viewing the front of the vehicle.

### Second Embodiment

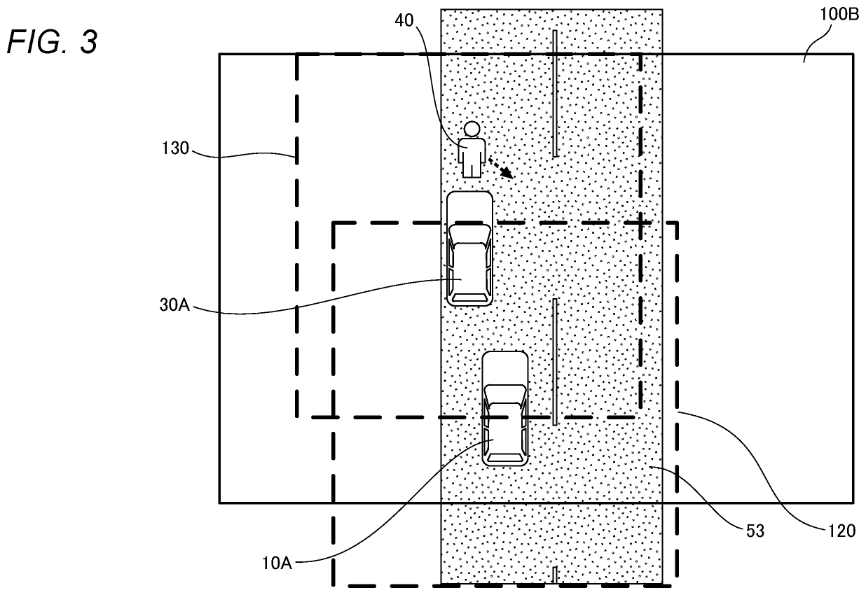

FIG. 3 is a diagram showing an example of a positional relationship between a host vehicle and another vehicle and a composite image according to a second embodiment. The second embodiment shows an example of generation of a composite image in a scene in which there is a vehicle parked or stopped on a road shoulder of a road on which the vehicle is traveling (a scene in which a parked or stopped vehicle is present) as a situation of the host vehicle corresponding to the scene satisfying the predetermined condition.

In the scene of the second embodiment, the first vehicle 10A, which is the host vehicle, is traveling on the road 53. In front of the first vehicle 10A, the second vehicle 30A, which is the another vehicle, is parked or stopped on the road shoulder of the road 53, and a person 40 stands in a shade of the second vehicle 30A and is likely to jump out to the road 53.

In this case, the person 40 is in a blind spot due to the second vehicle 30A that is a parked or stopped vehicle, and the front of the second vehicle 30A is out of the image capturing range that is out of the image capturing range 120 of the camera of the first vehicle 10A. Therefore, it is difficult for the first vehicle 10A to capture an image of the person 40 or the like in a shadow portion of the second vehicle 30A, and the person 40 cannot be recognized in the first vehicle 10A. On the other hand, the image capturing range 130 of the camera of the second vehicle 30A includes a front region that is the blind spot of the first vehicle 10A, and an image of the person 40 can be captured from the second vehicle 30A. Therefore, the person 40 is included in the captured image of the second vehicle 30A.

In the present embodiment, when the second vehicle 30A is stopped in a traveling lane on which the first vehicle 10A travels, in the first vehicle 10A, an other-produced image captured by the second vehicle 30A is acquired, and a composite image 100B is generated using the self-produced image captured by the host vehicle and the acquired other-produced image. In this case, the captured image is requested from the first vehicle 10A to the second vehicle 30A and acquired as the other-produced image. The second vehicle 30A is in a sleep state in which only a reception function is active. When a request is received from the first vehicle 10A, the second vehicle 30A activates the camera to capture an image, transmits the captured image to the first vehicle 10A, and then returns to the sleep state. Alternatively, the moving object such as the person may be detected in the second vehicle 30A, the camera may be activated to capture the image when occurrence of an event of the moving object or the like is detected, and the captured image may be transmitted to the first vehicle 10A. The second vehicle 30A captures the image with the camera when the event occurs, notifies the first vehicle 10A of completion of preparation for transmission of the captured image, and transmits the captured image from the second vehicle 30A to the first vehicle 10A as the other-produced image. Alternatively, the second vehicle 30A transmits an event detection signal to the first vehicle 10A, and transmits the captured image to the first vehicle 10A in response to the request from the first vehicle 10A. Communication such as image transmission between the first vehicle 10A and the second vehicle 30A may be VtoV communication, 5G mobile communication, network communication of a computer network using a wireless LAN or the like, or the like. When the first vehicle 10A and the second vehicle 30A attempt to communicate with the surroundings at a predetermined timing and can communicate with each other, the first vehicle 10A, the second vehicle 30A, and the third vehicle 30B may hold, as status information, information indicating that a connectable vehicle is present nearby the host vehicle, and transmit and receive image data and the like. The captured images may be composited not only with the host vehicle and a single another vehicle, but also with the host vehicle and a plurality of other vehicles, and images acquired in any of the plurality of vehicles may be composited.

In the example of FIG. 3, the composite image 100B of the bird's-eye view image viewed from above the host vehicle is shown. In the composite image 100B, the first vehicle 10A of the host vehicle is displayed at, for example, a lower center position. The composite image 100B also includes an image of the person 40 present in the shade of the second vehicle 30A, and the occupant (driver, fellow passenger) of the first vehicle 10A can recognize an object such as a person or a bicycle in a region that cannot be captured by the host vehicle. Accordingly, the presence of an obstacle in the shadow of the second vehicle 30A can be grasped in advance, and it is possible to cope with the person, the bicycle, or the like jumping out from the shadow of the parked or stopped vehicle.

In addition, when the host vehicle includes the notification unit, it is possible to notify the user of the presence of the moving object such as the person, and to cause the user to recognize the moving object such as the person or the bicycle outside the image capturing range or a characteristic object to be noted at an early stage.

### Third Embodiment

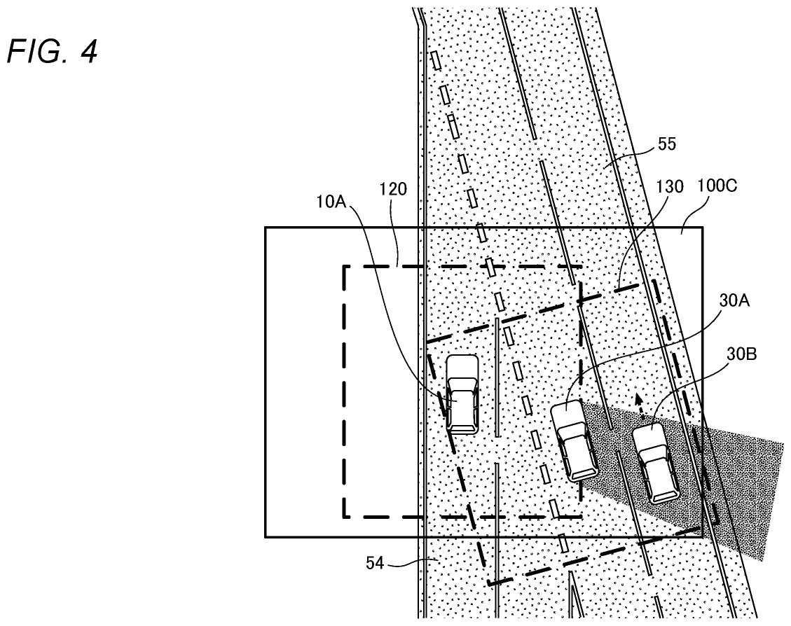

FIG. 4 is a diagram showing an example of a positional relationship between a host vehicle and another vehicle and a composite image according to a third embodiment. The third embodiment shows an example of generation of a composite image in a scene (merging scene) in which the host vehicle merges with a main road such as an expressway or a bypass from a merging lane as a situation of the host vehicle corresponding to a scene satisfying the predetermined condition.

In the scene of the third embodiment, the first vehicle 10A, which is the host vehicle, is traveling in the merging lane 54 of the expressway. On a main road 55 of the expressway, the second vehicle 30A, which is another vehicle, travels in a first lane, and the third vehicle 30B, which is another vehicle, travels in an adjacent second lane. In this case, the third vehicle 30B becomes a blind spot from the first vehicle 10A due to the second vehicle 30A, a soundproof wall of the expressway, or the like, and is out of the image capturing range that is out of the image capturing range 120 of the camera of the first vehicle 10A. Therefore, it is difficult for the first vehicle 10A to capture an image of the third vehicle 30B, the captured image of the first vehicle 10A does not include the third vehicle 30B, and the first vehicle 10A cannot recognize the third vehicle 30B traveling on the second lane of the main road 55. On the other hand, the image capturing range 130 of the camera of the second vehicle 30A includes the third vehicle 30B together with the second vehicle 30A, and an image of the third vehicle 30B can be captured from the second vehicle 30A. Therefore, the third vehicle 30B is included in the captured image of the second vehicle 30A.

In the present embodiment, when the traveling lane of the first vehicle 10A and the traveling lane of the second vehicle 30A merge, in the first vehicle 10A, the other-produced image captured by the second vehicle 30A is acquired, and a composite image 100C is generated using the self-produced image captured by the host vehicle and the acquired other-produced image. The third vehicle 30B may be used as the another vehicle instead of the second vehicle 30A, and the other-produced image captured by the third vehicle 30B may be acquired from the third vehicle 30B and composited. Communication such as image transmission between the first vehicle 10A and the second vehicle 30A or the third vehicle 30B may use the VtoV communication, the 5G mobile communication, or the like as in the first embodiment. The transmission of the captured image may be performed by requesting the captured image from the first vehicle 10A to the second vehicle 30A or the third vehicle 30B and acquiring the captured image as the other-produced image when the host vehicle merges, or may be performed by transmitting the captured image from the second vehicle 30A or the third vehicle 30B to the nearby first vehicle 10A when the host vehicle approaches a merging point. When the first vehicle 10A, the second vehicle 30A, and the third vehicle 30B attempt to communicate with the surroundings at a predetermined timing and can communicate with each other, the first vehicle 10A, the second vehicle 30A, and the third vehicle 30B may hold, as status information, information indicating that a connectable vehicle is present nearby the host vehicle, and transmit and receive image data and the like. The captured images may be composited not only with the host vehicle and a single another vehicle, but also with the host vehicle and a plurality of other vehicles, and images acquired in any of the plurality of vehicles may be composited.

In the example of FIG. 4, the composite image 100C of the bird's-eye view image viewed from above the host vehicle is shown. In the composite image 100C, the first vehicle 10A of the host vehicle is displayed, for example, at a position of the center of the image. The composite image 100C includes an image of the second vehicle 30A traveling on the first lane of the main road 55 of the expressway and an image of the third vehicle 30B traveling on the second lane, and an occupant (driver, fellow passenger) of the first vehicle 10A can recognize the presence of an object such as the third vehicle 30B in a region that cannot be captured by the host vehicle. Accordingly, since it is possible to enlarge a region in which it is possible to confirm even the region outside the image capturing range or the region of the blind spot, and it is possible to confirm the vehicle in a further distant and wider range, it is possible to further improve safety at the time of merging of the vehicle.

When the AR-HUD is used as the display unit, the visible composite image is superimposed and displayed on the front window of the host vehicle. Accordingly, since the third vehicle traveling in the blind spot region outside the image capturing range can be displayed in the visible composite image together with the second vehicle, the driver and the occupant can visually recognize the composite image in a state of facing the front of the vehicle, can recognize the approach of the third vehicle together with the real image of the field of view, and can smoothly merge in a state of further increasing the safety.

### Fourth Embodiment

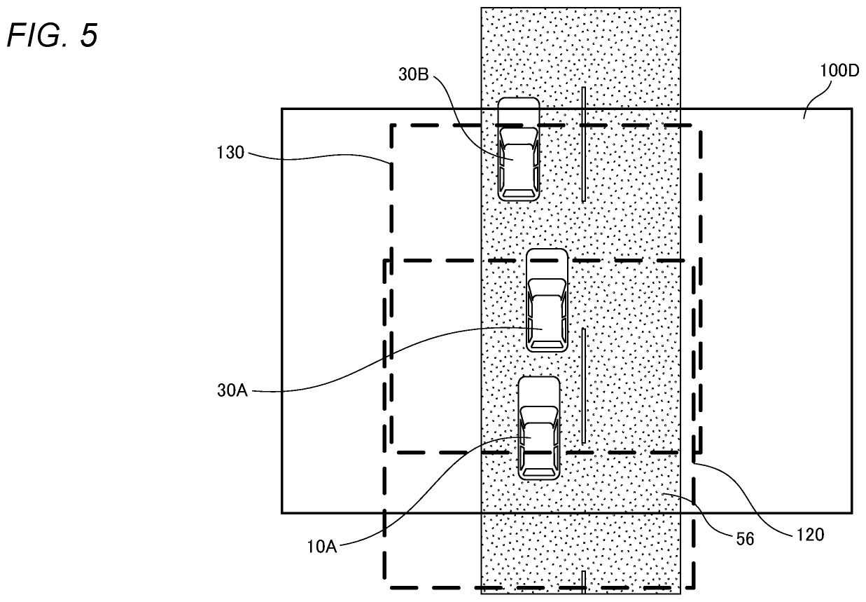

FIG. 5 is a diagram showing an example of a positional relationship between a host vehicle and another vehicle and a composite image according to a fourth embodiment. The fourth embodiment shows an example of generation of a composite image in a scene (a scene such as traffic congestion) in which an event such as traffic congestion occurs in front of a road on which the vehicle is traveling, as a situation of the host vehicle corresponding to a scene satisfying the predetermined condition.

In the scene of the fourth embodiment, the second vehicle 30A, which is another vehicle, travels ahead of the road 56 on which the first vehicle 10A, which is the host vehicle, is traveling, and the third vehicle 30B, which is a parked vehicle of another vehicle, is parked on a road shoulder in front of the second vehicle 30A. The third vehicle 30B, which is the parked vehicle, decelerates or stops the second vehicle 30A, the first vehicle 10A, which is the host vehicle, and the following vehicles, and traffic congestion occurs. In this case, the third vehicle 30B becomes a blind spot due to the second vehicle 30A, and the front of the second vehicle 30A is out of the image capturing range that is out of the image capturing range 120 of the camera of the first vehicle 10A. Therefore, it is difficult for the first vehicle 10A to capture an image of the third vehicle 30B or the like, which is the parked vehicle, and the traffic situation in front of the first vehicle 10A in the traveling direction cannot be recognized. On the other hand, the image capturing range 130 of the camera of the second vehicle 30A includes a front region outside the image capturing range of the first vehicle 10A, and an image of the third vehicle 30B can be captured from the second vehicle 30A. Therefore, the third vehicle 30B is included in the captured image of the second vehicle 30A.

In the present embodiment, in the first vehicle 10A, an other-produced image captured by the second vehicle 30A is acquired, and a composite image 100D is generated using the self-produced image captured by the host vehicle and the acquired other-produced image. In this case, the second vehicle 30A is at least one of vehicles including a vehicle in front of the first vehicle 10A in the traveling direction and a vehicle in front of the first vehicle 10A and in an oncoming direction opposing the vehicle. In the shown example, the second vehicle 30A is the vehicle in front of the first vehicle 10A in the traveling direction. The transmission of the captured image may be performed by requesting the captured image from the first vehicle 10A of the host vehicle to the second vehicle 30A of the another vehicle and acquiring the captured image as the other-produced image, or may be performed by transmitting the captured image from the second vehicle 30A to the first vehicle 10A when the second vehicle 30A detects the occurrence of an event such as the parked or stopped vehicle or the traffic congestion. When the first vehicle 10A and the second vehicle 30A attempt to communicate with the surroundings at a predetermined timing and can communicate with each other, the first vehicle 10A, the second vehicle 30A, and the third vehicle 30B may hold, as status information, information indicating that a connectable vehicle is present nearby the host vehicle, and transmit and receive image data and the like. The captured images may be composited not only with the host vehicle and a single another vehicle, but also with the host vehicle and a plurality of other vehicles, and images acquired in any of the plurality of vehicles may be composited.

In the example of FIG. 5, the composite image 100D of the bird's-eye view image viewed from above the host vehicle is shown. In the composite image 100D, the first vehicle 10A of the host vehicle is displayed at, for example, a lower center position. The composite image 100D also includes an image of the third vehicle 30B of the parked vehicle present in front of the second vehicle 30A, and the occupant (driver, fellow passenger) of the first vehicle 10A can recognize the occurrence of an event such as the parked vehicle, the traffic congestion, road surface freezing, unevenness of a road, and an accident in a region that cannot be captured by the host vehicle, and the traffic situation. Accordingly, the traffic situation in front of the second vehicle 30A can be grasped in a wide range.

In addition, as an application example of the fourth embodiment, an other-produced image captured by another vehicle in front of the road on which the host vehicle is traveling in the traveling direction and another vehicle in front of the host vehicle and in an oncoming direction opposing the vehicle may be acquired, and the other-produced image and the self-produced image may be composited to generate a composite image covering a wider range. That is, the second vehicle as the another vehicle is at least one of the vehicles including the vehicle in front of the first vehicle as the host vehicle in the traveling direction and the vehicle in front of the first vehicle and din the oncoming direction opposing the vehicle, and the captured image captured by the second vehicle is acquired and composited as the other-produced image. In this case, for example, an image captured by each vehicle is transmitted to a server device as probe information including event information, a composite image such as a bird's-eye view image of a wide range is generated and accumulated in the server device together with road traffic information, the server device distributes the composite image in response to a request from the host vehicle, and the composite image is acquired and displayed in the host vehicle. Alternatively, the composite image may be generated by acquiring a captured image of a desired range from the host vehicle using the captured images of the wide range of vehicles accumulated in the server device. It is also possible to transfer the captured images between a plurality of vehicles by a relay method without using the server device, acquire the captured images captured by the plurality of vehicles, and generate the composite image in the wide range. In the application example, the composition with the self-produced image is not essential, and a composite image between others may be acquired from the server device and displayed on the host vehicle. A medium that acquires and displays the composite image between other vehicles from the server device is not limited to the display device of the host vehicle, and may be a form in which the composite image is displayed on a mobile terminal of a user including a personal computer, a smartphone, a tablet terminal, and the like.

According to such an application example, it is possible to display the composite image of the bird's-eye view image in which a large number of captured images are composited and the wide range is overlooked, and it is possible to easily recognize the occurrence of the event in a wider range, the current road condition, and the traffic situation, such as the presence of a large hole on a road 5 km ahead of the host vehicle, the occurrence of road surface freezing, and the occurrence of traffic congestion 3 km ahead.

### Fifth Embodiment

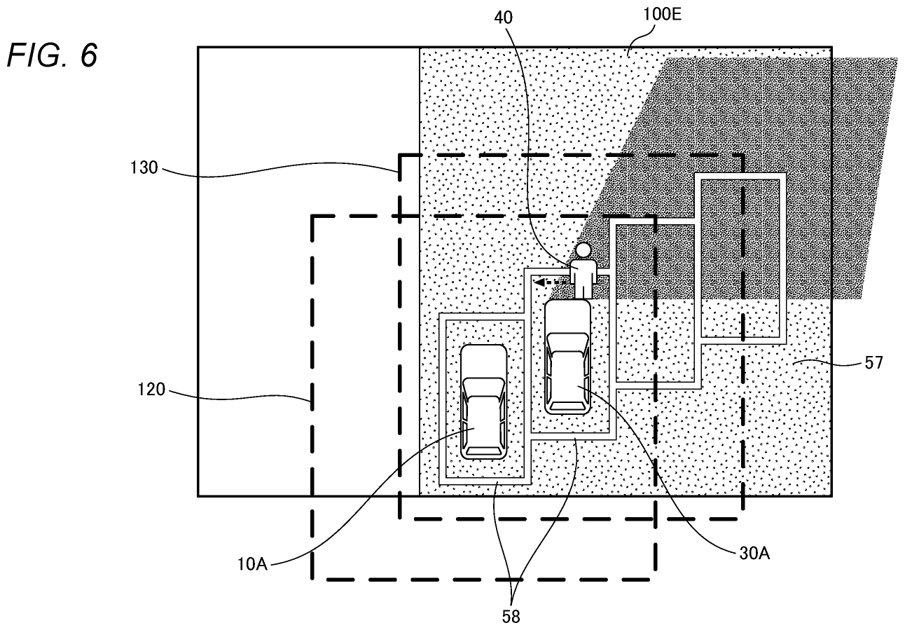

FIG. 6 is a diagram showing an example of a positional relationship between a host vehicle and another vehicle and a composite image according to a fifth embodiment. The fifth embodiment shows an example of generation of a composite image in a scene (a scene of a parking lot) in which another vehicle of a parked vehicle is present nearby when parking in a parking lot having a plurality of parking spaces as a situation of the host vehicle corresponding to a scene satisfying the predetermined condition.

The scene of the fifth embodiment is a situation in which the first vehicle 10A, which is the host vehicle, is parked in one of the plurality of parking spaces 58 provided in a parking lot 57 and is now going to exit the parking lot 57. Alternatively, this is a situation in which the first vehicle 10A is entering one of the parking spaces 58. For example, such a scene occurs in a service area of an expressway, a parking lot of a commercial facility, or the like. The second vehicle 30A, which is another vehicle, is parked in the adjacent parking space 58, and the person 40 stands in the shade of the second vehicle 30A and tries to walk in the direction of the host vehicle. The second vehicle 30A is not limited to being adjacent to the first vehicle 10A, and may be parked at any position in the parking lot, such as the nearby parking space 58. In this case, the person 40 is in a blind spot due to the parked second vehicle 30A, and the front of the second vehicle 30A is out of the image capturing range that is out of the image capturing range 120 of the camera of the first vehicle 10A. Therefore, it is difficult for the first vehicle 10A to capture an image of the person 40 or the like in a shadow portion of the second vehicle 30A, and the person 40 cannot be recognized in the first vehicle 10A. On the other hand, the image capturing range 130 of the camera of the second vehicle 30A includes a front region that is the blind spot of the first vehicle 10A, and an image of the person 40 can be captured from the second vehicle 30A. Therefore, the person 40 is included in the captured image of the second vehicle 30A.

In the present embodiment, when the first vehicle 10A enters or exits the parking lot and the second vehicle 30A is parked at any position in the parking lot, in the first vehicle 10A, an other-produced image captured by the second vehicle 30A is acquired, and a composite image 100E is generated using the self-produced image captured by the host vehicle and the acquired other-produced image. Communication such as image transmission between the first vehicle 10A and the second vehicle 30A may use the VtoV communication, the 5G mobile communication, the network communication of the computer network using the wireless LAN or the like, as in the second embodiment. The transmission of the captured image may be performed by requesting the captured image from the first vehicle 10A to the second vehicle 30A when the host vehicle enters or exits the parking lot and acquiring the captured image as the other-produced image, or may be performed by transmitting the captured image from the second vehicle 30A to the nearby first vehicle 10A when the moving object is detected in the second vehicle 30A. When the first vehicle 10A and the second vehicle 30A attempt to communicate with the surroundings at a predetermined timing and can communicate with each other, the first vehicle 10A, the second vehicle 30A, and the third vehicle 30B may hold, as status information, information indicating that a connectable vehicle is present nearby the host vehicle, and transmit and receive image data and the like. The captured images may be composited not only with the host vehicle and a single another vehicle, but also with the host vehicle and a plurality of other vehicles, and images acquired in any of the plurality of vehicles may be composited.

In the example of FIG. 6, the composite image 100E of the bird's-eye view image viewed from above the host vehicle is shown. In the composite image 100E, the first vehicle 10A of the host vehicle is displayed at, for example, a lower center position. The composite image 100E also includes an image of the person 40 present in the shade of the second vehicle 30A, and the occupant (driver, fellow passenger) of the first vehicle 10A can recognize an object such as a person in a region that cannot be captured by the host vehicle. Accordingly, the presence of an obstacle in the shadow of the second vehicle 30A can be grasped in advance at the time of starting to enter or exit the parking lot or at the time of traveling, and it is possible to cope with the person or the like jumping out from the shadow of the parked vehicle.

In addition, when the host vehicle includes the notification unit, it is possible to notify the user of the presence of the moving object such as the person and to cause the user to recognize the object such as the person or the bicycle outside the image capturing range at an early stage.

Hereinafter, a generation operation of the visible composite image using the other-produced image together with the self-produced image will be specifically described by an example.

### Example of Generation Processing of Composite Image

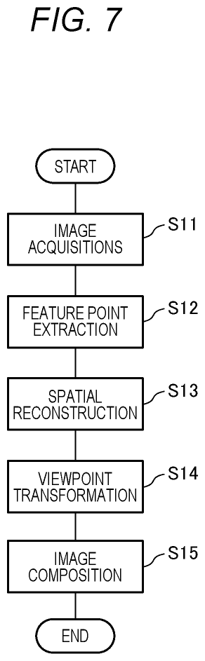

FIG. 7 is a flowchart showing an example of generation processing of the visible composite image. FIG. 7 shows an example in which the acquisition unit 11 and the composition unit 12 of the host vehicle 10 generate a composite image.

The acquisition unit 11 of the host vehicle 10 acquires a captured image of the self-produced image from the cameras 21A, 21B, 21C, and 21D mounted on the host vehicle. The acquisition unit 11 communicates with the another vehicle 30 and acquires the captured image of the other-produced image from the camera 31 of the another vehicle 30. The captured image of the other-produced image may be acquired by communicating with another image capturing unit provided in an infrastructure such as a road shoulder of a road, a traffic light, a sign, a guide board, a pedestrian bridge, or an elevated road. In this manner, the acquisition unit 11 acquires the captured image of the other-produced image in addition to the self-produced image (S11).

In order to generate a composite image such as a bird's-eye view image from a plurality of captured images, it is possible to generate a composite image viewed from a desired viewpoint by performing processing such as spatial reconstruction and viewpoint transformation of a plurality of captured images using a technique in the related art described in, for example, JP-B2-3286306. In the case of only the camera of the host vehicle, the position of each camera and the angle of view of the captured image are known in advance, and a relative position between the cameras and the image capturing range of each camera are defined by adjustment at the time of shipment or the like. Therefore, when the composite image is generated, it is possible to rearrange each pixel of a subject in a plurality of captured images in a three-dimensional space and composite the pixels.

On the other hand, as in the present embodiment, when the other-produced image is used in addition to the self-produced image, feature points existing in common in the plurality of captured images are extracted, and the pixels are rearranged in the three-dimensional space so as to match the three-dimensional positions of the feature points based on likelihood of the feature points, and the plurality of captured images are composited.

A high-precision positioning system such as a quasi-zenith satellite system (QZSS) or a light detection and ranging (LiDAR) may be used to detect the relative position of the another vehicle and the plurality of image capturing units of the host vehicle, and the composite image may be generated based on the position information of each image capturing unit.

The composition unit 12 of the host vehicle 10 extracts the feature points in the plurality of captured images to be composited (S12). As the feature point, a boundary line of the road, a white line or a yellow line indicating a lane, a white line indicating a parking space, a fixed object at a road peripheral portion such as a guardrail or a soundproof wall, or the like may be used.

The composition unit 12 executes spatial reconstruction processing of the captured images based on the likelihood of the feature points extracted in the acquired plurality of captured images (S13). At this time, the composition unit 12 calculates a correspondence relationship between each pixel of the subject and the point in the three-dimensional coordinate system based on the likelihood of the feature points, and rearranges the feature point in the three-dimensional space so as to match the three-dimensional position of the feature point.

Subsequently, the composition unit 12 performs viewpoint transformation processing to a predetermined viewpoint position so that, for example, a vertically upper side of the host vehicle 10 is set as the viewpoint position using the pixel information of each pixel rearranged in the three-dimensional space (S14). Then, the composition unit 12 composites each pixel of the captured image after the viewpoint transformation, and generates the composite image of the bird's-eye view image viewed down from directly above the host vehicle 10 (S15). The viewpoint position is not limited to a position directly above the host vehicle 10, and a predetermined position such as a position obliquely above the host vehicle 10 can be set, and a composite image from a desired viewpoint such as a bird's-eye view image viewed from obliquely above can be generated.

In this way, by generating the composite image of the bird's-eye view image including the captured image of the other-produced image together with the self-produced image, it is possible to obtain the visible composite image of a wide range including the region outside the image capturing range of the host vehicle, and it is possible to enlarge a visual recognition range of the user.

### First Example of Acquisition Operation of Other-Produced Image

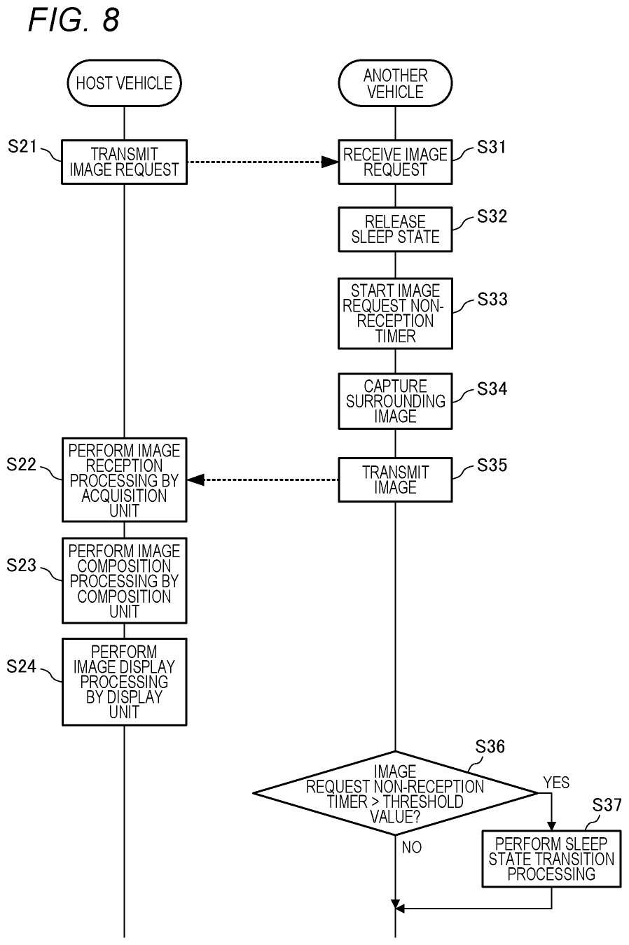

FIG. 8 is a sequence diagram showing a first example of an image acquisition operation of acquiring a captured image of an other-produced image. The first example shows an operation example when the host vehicle requests another vehicle having another image capturing unit to acquire an other-produced image. In the first example, it is assumed that, when the host vehicle acquires the other-produced image captured by another image capturing unit and generates a composite image, the another vehicle that is an image acquisition destination is in a sleep state during parking or the like. At this time, the another vehicle stops the image capture by its own image capturing unit, and stops the composition processing, the display processing, and the like of the captured image, and the image capturing unit and the control unit are in the sleep state.

In a scene satisfying a predetermined condition, the acquisition unit 11 of the host vehicle 10 transmits an image request for the other-produced image to an own communication area, and transmits the image request to the another vehicle 30 present nearby (S21). When the control unit of the another vehicle 30 receives the image request from the nearby vehicle in the sleep state (S31), the control unit of the another vehicle 30 is activated to release the sleep state of the camera 31 which is the image capturing unit (S32), and starts an image request non-reception timer which measures a period in which the image request is not received (S33). Then, the control unit of the another vehicle 30 captures a surrounding image with the camera 31 (S34), and transmits the captured image to the host vehicle 10 that receives the image request (S35).

The acquisition unit 11 of the host vehicle 10 performs image reception processing on the captured image of the other-produced image transmitted from the another vehicle 30 to acquire the other-produced image (S22). The acquisition unit 11 acquires a captured image of the self-produced image captured by the cameras 21A to 21D which are image capturing units of the host vehicle 10. The composition unit 12 of the host vehicle 10 executes the image composition processing as shown in FIG. 7 using the acquired captured images of the self-produced image and the other-produced image, and generates a composite image of the bird's-eye view image (S23). Then, the display unit 13 of the host vehicle 10 executes image display processing of the generated composite image, and displays the composite image of the bird's-eye view image (S24). For example, when an AR-HUD is used as the display unit 13, a composite image is superimposed and displayed on the front window of the host vehicle by the AR technology, so that the user can visually recognize a real image of the field of view in front of the vehicle and a composite image representing the current surrounding situation of the vehicle.

The control unit of the another vehicle 30 monitors a value of the image request non-reception timer and determines whether the value of the image request non-reception timer exceeds a predetermined threshold value (S36). Here, when the value of the image request non-reception timer exceeds the predetermined threshold value, that is, when the period in which the image request is not received is equal to or longer than a predetermined time, the control unit of the another vehicle 30 executes sleep state transition processing to cause the image capturing unit and the control unit to transition to the sleep state (S37). Accordingly, the another vehicle 30 returns to the state before receiving the image request, and waits in the sleep state.

In this manner, it is possible to transmit a request from the host vehicle to the another vehicle in a predetermined scene, acquire a captured image of the other-produced image, and generate a visible composite image including the self-produced image and the other-produced image.

### Second Example of Acquisition Operation of Other-Produced Image

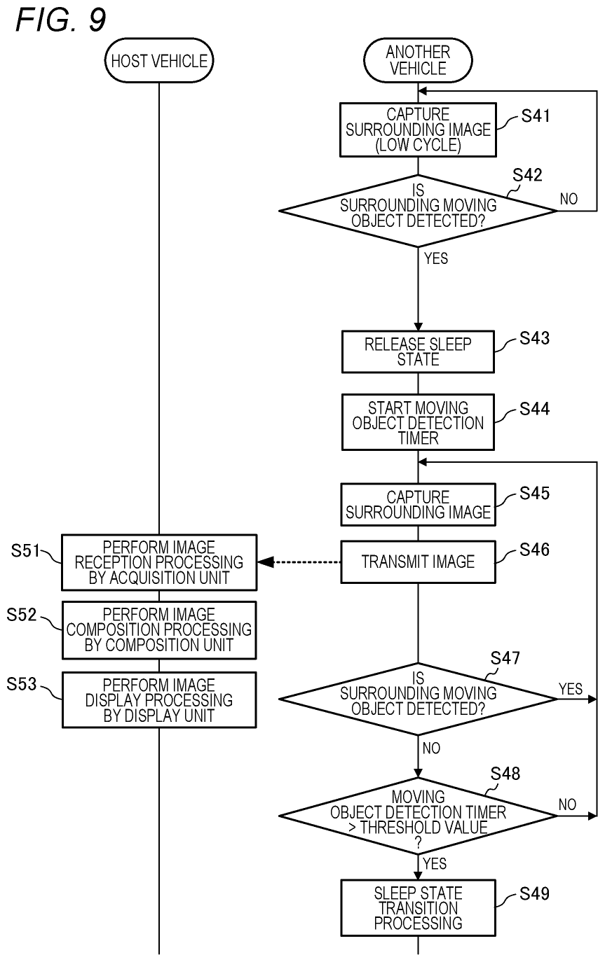

FIG. 9 is a sequence diagram showing a second example of an image acquisition operation of acquiring a captured image of an other-produced image. The second example shows an operation example when a moving object surrounding the another vehicle is detected, the another vehicle is activated from the sleep state, and an other-produced image is transmitted to and acquired by the host vehicle. In the second example, it is assumed that a function of detecting the moving object is enabled when the another vehicle is in the sleep state during parking or the like, and a surrounding image is captured at a low cycle.

The control unit of the another vehicle 30 captures the surrounding image at a low cycle by the camera 31 in the sleep state (S41). Here, the control unit of the another vehicle 30 determines whether a surrounding moving object is detected by a sensor mounted on the another vehicle 30 as a scene satisfying the predetermined condition (S42). As the sensor for detecting the moving object, various sensors such as a vibration sensor, an acceleration sensor, and an infrared sensor may be used. Here, when the moving object such as the person is detected in the vicinity of the another vehicle 30, the control unit of the another vehicle 30 is activated to release the sleep state of the camera 31 which is the image capturing unit (S43), and starts a moving object detection timer which measures a period from the detection of the moving object (S44). Then, the control unit of the another vehicle 30 captures the surrounding image with the camera 31 (S45), and makes a connection request to the surrounding vehicle to confirm whether there is a vehicle capable of acquiring the captured image in its own communication area. Subsequently, the control unit of the another vehicle 30 transmits the captured image to the host vehicle 10 nearby the host vehicle (S46).

The acquisition unit 11 of the host vehicle 10 performs image reception processing on the captured image of the other-produced image transmitted from the another vehicle 30 to acquire the other-produced image (S51). The acquisition unit 11 acquires a captured image of the self-produced image captured by the cameras 21A to 21D which are image capturing units of the host vehicle 10. The composition unit 12 of the host vehicle 10 executes the image composition processing as shown in FIG. 7 using the acquired captured images of the self-produced image and the other-produced image, and generates a composite image of the bird's-eye view image (S52). Then, the display unit 13 of the host vehicle 10 executes image display processing of the generated composite image, and displays the composite image of the bird's-eye view image (S53).

After the image transmission processing, the control unit of the another vehicle 30 determines whether the surrounding moving object is still detected (S47), and when the detection of the moving object is continued, the processing returns to step S45 and continues the processing of capturing and transferring the surrounding image. When the moving object is not detected in the vicinity, the control unit of the another vehicle 30 monitors a value of the moving object detection timer and determines whether the value of the moving object detection timer exceeds a predetermined threshold value (S48). Here, when the value of the moving object detection timer exceeds the predetermined threshold value, that is, when the moving object detection is not continued after the moving object is detected and the predetermined time elapses, the control unit of the another vehicle 30 executes the sleep state transition processing to cause the image capturing unit and the control unit to transition to the sleep state (S49). Accordingly, the another vehicle 30 returns to the state before the moving object is detected, and waits in the sleep state.

In this manner, it is possible to transmit the captured image from the another vehicle to the host vehicle in the predetermined scene, acquire the captured image of the other-produced image by the host vehicle, and generate the visible composite image including the self-produced image and the other-produced image.

The moving body on which the driving assistance device according to the present embodiment is mounted is not limited to a vehicle such as an automobile and a truck, and is also applicable to a flying body such as a drone and other moving bodies.

According to the present embodiment, with respect to a region outside the image capturing range (including a region outside the image capturing range due to a blind spot) that cannot be captured by the own moving body, a captured image captured by another image capturing unit is acquired, and the captured image and the captured image captured by the own moving body are subjected to the image composition to obtain a visible composite image. Therefore, it is possible to generate an appropriate image according to the operation state of the moving body, the surrounding state, and the like without being limited to the image capturing range of the user, and the user can also confirm a region outside the image capturing range of the camera mounted on the moving body such as the vehicle.

As described above, the driving assistance device, the driving assistance method, and the program according to the present embodiment are driving assistance devices for assisting driving of the moving body such as the vehicle, and include, for example, a processing unit (for example, a processing device) by the composition unit 12 or the like including a processor and a memory, and the acquisition unit 11 (for example, an interface such as a camera interface or a communication interface) having a communication function. For example, the host vehicle 10 includes the acquisition unit 11 and the composition unit 12. The acquisition unit 11 inputs and acquires a self-produced image obtained by capturing the image of the surroundings of the moving body by the image capturing units (the cameras 21A, 21B, 21C, and 21D) mounted on the own moving body (the host vehicle 10) and an other-produced image obtained by capturing the image of the surroundings of the moving body by another image capturing unit (the camera 31 of the another vehicle 30). The composition unit 12 as the processing unit composites a plurality of images including the self-produced image and the other-produced image to generate a visible composite image. Accordingly, even outside the image capturing range of the self-produced image, the other-produced image can be acquired and composited, and the range shown in the visible composite image can be enlarged. For example, the presence of the object such as another moving body or the person present outside the image capturing range of the own moving body can be grasped by the visible composite image. Therefore, it is possible to generate an appropriate image according to the operation state, the surrounding state, and the like of the moving body such as the vehicle and to perform driving assistance.

When generating the visible composite image, the composition unit 12 as the processing unit may composite a first composite image obtained by compositing a plurality of self-produced images and a second composite image obtained by compositing a plurality of other-produced images. When generating the visible composite image, the composition unit 12 as the processing unit may composite each of the plurality of self-produced images and each of one or a plurality of other-produced images. When generating the visible composite image, the composition unit 12 as the processing unit may composite the first composite image obtained by compositing the plurality of self-produced images and one or a plurality of other-produced images. Accordingly, it is possible to generate the visible composite image by appropriately compositing the self-produced image and the other-produced image according to the situation.

The composition unit 12 as the processing unit may extract feature points in each of the self-produced image and the other-produced image, and composite a plurality of images including the self-produced image and the other-produced image based on the likelihood of the feature points. Accordingly, it is possible to rearrange each pixel in the three-dimensional space so as to match the three-dimensional position of the feature points based on the likelihood of the feature points in each image, and composite a plurality of captured images. The relative positions of the image capturing unit of the own moving body and the other image capturing units may be detected, and the composite image may be generated based on the position information of each image capturing unit. Accordingly, it is possible to rearrange each pixel of the plurality of captured images on the three-dimensional space based on the position information of each image capturing unit and composite the plurality of captured images.

The composition unit 12 as the processing unit may rearrange each pixel of the subject in each image of the self-produced image and the other-produced image on the three-dimensional space, perform the viewpoint transformation processing to a predetermined viewpoint position, composite a plurality of images, and generate a visible composite image. Accordingly, a composite image subjected to the viewpoint transformation processing is generated, and for example, a bird's-eye view image viewed from directly above the own moving body, a bird's-eye view image viewed from a predetermined viewpoint position, or the like is displayed, so that the user can easily confirm the current surrounding situation.

The composition unit 12 as the processing unit may provide the composite image to the display unit 13 and cause the display unit 13 (for example, a display device) to display the visible composite image. Accordingly, the user can easily confirm the current surrounding situation by displaying the visible composite image on the display unit 13. By providing the display unit 13 in the host vehicle 10 that is the own moving body, the user can easily confirm the visible composite image indicating the current surrounding situation.

The display unit 13 may be a display device including the AR-HUD. By using the AR-HUD as the display unit 13, the user can visually recognize the surrounding real image and the visible composite image in a state in which the user faces the front, and operability and visibility during driving can be improved.

The composition unit 12 serving as the processing unit may transmit notification information to the notification unit when a predetermined object is present in the image of the visible composite image, and cause the notification unit to notify the user of the presence of the predetermined object. Accordingly, for example, by notifying the user with sound, light, or the like, it is possible to notify the user that the predetermined object is present in the surroundings and the surrounding situation becomes the predetermined state. By providing the notification unit in the host vehicle 10 that is the own moving body, the user can easily recognize the current surrounding situation.

In addition, the own moving body may be the host vehicle 10, and another image capturing unit may be an image capturing unit (the camera 31) mounted on the another vehicle 30 which is another moving body, or an image capturing unit mounted on a related facility installed on a road or a parking lot on which the host vehicle 10 travels. Accordingly, even outside the image capturing range of the host vehicle, the other-produced image can be acquired from the image capturing unit of the infrastructure of the another vehicle or the related facility and composited, and the presence of an obstacle such as another vehicle or a person present outside the image capturing range of the host vehicle can be grasped by the visible composite image.

When the first vehicle 10A as the host vehicle includes the acquisition unit 11, the composition unit 12 as the processing unit, and the display unit 13 that displays the visible composite image, the second vehicle 30A as the another vehicle includes the image capturing unit, and the traveling direction of the first vehicle 10A and the traveling direction of the second vehicle 30A intersect with each other, the acquisition unit 11 of the first vehicle may acquire the other-produced image captured by the image capturing unit (camera 31) of the second vehicle from the second vehicle, and the composition unit 12 as the processing unit of the first vehicle may composite the self-produced image captured by the image capturing unit (cameras 21A, 21B, 21C, and 21D) included in the first vehicle and the other-produced image acquired from the second vehicle. Accordingly, for example, in the scene of the intersection, it is possible to recognize the another vehicle outside the image capturing range of the host vehicle, and it is possible to confirm the approach of the another vehicle from outside the image capturing range.

When the first vehicle 10A that is the host vehicle includes the acquisition unit 11, the composition unit 12 as the processing unit, and the display unit 13 that displays the visible composite image, the second vehicle 30A that is the another vehicle includes the image capturing unit, and the second vehicle 30A is stopped in the traveling lane on which the first vehicle 10A travels, the acquisition unit 11 of the first vehicle may acquire the other-produced image captured by the image capturing unit (camera 31) of the second vehicle from the second vehicle, and the composition unit 12 as the processing unit of the first vehicle may composite the self-produced image captured by the image capturing unit (cameras 21A, 21B, 21C, and 21D) included in the first vehicle and the other-produced image acquired from the second vehicle. Accordingly, for example, in the scene in which the parked or stopped vehicle is present, it is possible to recognize the object present in the blind spot outside the image capturing range of the host vehicle, to allow the presence of an obstacle such as the person present in the shade of the another vehicle to be grasped in advance, and to cope with jumping out or the like.

When the first vehicle 10A that is the host vehicle includes the acquisition unit 11, the composition unit 12 as the processing unit, and the display unit 13 that displays the visible composite image, the second vehicle 30A that is the another vehicle includes the image capturing unit, and the traveling lane of the first vehicle 10A and the traveling lane of the second vehicle 30A merge, the acquisition unit 11 of the first vehicle may acquire the other-produced image captured by the image capturing unit (camera 31) of the second vehicle from the second vehicle, and the composition unit 12 as the processing unit of the first vehicle may composite the self-produced image captured by the image capturing unit (cameras 21A, 21B, 21C, and 21D) included in the first vehicle and the other-produced image acquired from the second vehicle. Accordingly, for example, in the scene of merging, the region that can be confirmed by the host vehicle can be enlarged, and the another vehicle outside the image capturing range or in the blind spot can be recognized, so that the safety at the time of merging of the vehicle can be further enhanced.

When the first vehicle 10A as the host vehicle includes the acquisition unit 11, the composition unit 12 as the processing unit, and the display unit 13 that displays the visible composite image, the second vehicle 30A as the another vehicle includes the image capturing unit, the second vehicle 30A is at least one vehicle among vehicles including a vehicle in front of the first vehicle in the traveling direction and a vehicle in front of the first vehicle and in the oncoming direction opposing the vehicle, the acquisition unit 11 of the first vehicle may acquire the other-produced image captured by the image capturing unit (camera 31) of the second vehicle from the second vehicle, and the composition unit 12 as the processing unit of the first vehicle may composite the self-produced image captured by the image capturing unit (cameras 21A, 21B, 21C, and 21D) included in the first vehicle and the other-produced image acquired from the second vehicle. Accordingly, for example, in the scene such as the traffic congestion, it is possible to recognize the situation of the another vehicle or the like outside the image capturing range of the host vehicle, and it is possible to grasp the occurrence of an event such as the parked vehicle, the traffic congestion, the road surface freezing, the road unevenness, and the accident in a region of which an image cannot be captured by the host vehicle, and the traffic situation in a wide range.

When the first vehicle 10A as the host vehicle includes the display unit 13 that displays the visible composite image, the second vehicle 30A as the another vehicle includes the image capturing unit, the server device capable of communicating with the host vehicle and the another vehicle includes the acquisition unit 11 and the composition unit 12 as the processing unit, the second vehicle 30A is at least one vehicle among the vehicles including the vehicle in front of the first vehicle in the traveling direction and the vehicle in front of the first vehicle and in the oncoming direction opposing the vehicle, the acquisition unit 11 of the server device may acquire the other-produced image captured by the image capturing unit (camera 31) of the second vehicle from the second vehicle, and the composition unit 12 as the processing unit of the server device may composite the self-produced image captured by the image capturing unit (cameras 21A, 21B, 21C, and 21D) included in the first vehicle and the other-produced image acquired from the second vehicle, and may transmit the visible composite image to the display unit 13 of the first vehicle. Accordingly, it is possible to display the composite image of the bird's-eye view image obtained by compositing a large number of captured images and overlooking in a wide range, and it is possible to easily recognize the occurrence of the event in a wider range, the current road condition, and the traffic situation, such as the road condition of several kilometers ahead.

When the first vehicle 10A as the host vehicle includes the acquisition unit 11, the composition unit 12 as the processing unit, and the display unit 13 that displays the visible composite image, the second vehicle 30A as the another vehicle includes the image capturing unit, the first vehicle enters or exits the parking lot, and the second vehicle is parked at any position in the parking lot, the acquisition unit 11 of the first vehicle may acquire the other-produced image captured by the image capturing unit (camera 31) of the second vehicle from the second vehicle, and the composition unit 12 as the processing unit of the first vehicle may composite the self-produced image captured by the image capturing unit (cameras 21A, 21B, 21C, and 21D) included in the first vehicle and the other-produced image acquired from the second vehicle. Accordingly, for example, in the scene of the parking lot, it is possible to recognize an object in the region that cannot be captured by the host vehicle, and it is possible to grasp in advance the presence of an obstacle such as the person in the shadow of the another vehicle at the time of starting to enter or exit the parking lot or at the time of traveling, and it is possible to cope with the jumping out of the person or the like from the shadow of the parked vehicle.

Although the various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present invention. Components in various embodiments described above may be combined optionally in a range without deviating from the spirit of the invention.

The present application is based on Japanese Patent Application (Japanese Patent Application No. 2019-235099) filed on Dec. 25, 2019, and contents thereof are incorporated herein by reference.

The present disclosure has an effect of generating an appropriate image according to an operation state, a surrounding state, and the like of a moving body such as a vehicle and performing driving assistance, and is useful as a driving assistance device, a driving assistance method, and a program for assisting driving of the moving body such as the vehicle.

What is claimed is:

1. A driving assistance device for assisting driving of a moving body, the driving assistance device comprising:
a processor; and
a memory storing instructions that, when executed by the processor, cause the driving assistance device to perform operations comprising:
acquiring a self-produced image obtained by capturing an image of a surrounding of a moving body by a first image capturing device mounted on the moving body and an other-produced image captured by a second image capturing device different from the first image capturing device; and
generating a visible composite image by compositing a plurality of images including the self-produced image and the other-produced image.

2. The driving assistance device according to claim 1,
wherein the generating the visible composite image comprises compositing a first composite image obtained by compositing a plurality of self-produced images and a second composite image obtained by compositing a plurality of other-produced images.

3. The driving assistance device according to claim 1,
wherein the generating the visible composite image comprises compositing each of a plurality of self-produced images and each of one or more other-produced images.

4. The driving assistance device according to claim 1,
wherein the generating the visible composite image comprises compositing a first composite image obtained by compositing a plurality of self-produced images and one or a plurality of other-produced images.

5. The driving assistance device according to claim 1,
wherein the generating the visible composite image comprises:
extracting a feature point in each of the self-produced image and the other-produced image; and
compositing a plurality of images including the self-produced image and the other-produced image based on a likelihood of the feature point.

6. The driving assistance device according to claim 1,
wherein the generating the visible composite image comprises:
rearranging each pixel of a subject in each of the self-produced image and the other-produced image in a three-dimensional space;
performing viewpoint transformation processing to a predetermined viewpoint position; and
compositing the plurality of images.

7. The driving assistance device according to claim 1,
wherein the operations further comprise providing the composite image to a display device to cause the display device to display the visible composite image.

8. The driving assistance device according to claim 7,
wherein the display device comprises an augmented reality head up display (AR-HUD).

9. The driving assistance device according to claim 1,
wherein the operations further comprise transmitting notification information to a notification device in a case in which a predetermined object is present in the image of the visible composite image, to cause the notification device to notify a user of a presence of the predetermined object.

10. The driving assistance device according to claim 1,
wherein the moving body is a host vehicle, and
wherein the second image capturing device is an image capturing device mounted on another vehicle serving as another moving body, or an image capturing device mounted on a related facility installed on a road or a parking lot on which the host vehicle travels.

11. The driving assistance device according to claim 10,
wherein a first vehicle serving as the host vehicle comprises the first image capturing device, the processor, and a display device configured to display the visible composite image,
wherein a second vehicle serving as the another vehicle comprises the second image capturing device, and
wherein in a case in which a traveling direction of the first vehicle and a traveling direction of the second vehicle intersect with each other, the operations comprise causing the first vehicle to:
acquire the other-produced image from the second vehicle, the other-produced image being captured by the second image capturing device; and
composite the self-produced image captured by the first image capturing device and the other-produced image acquired from the second vehicle.

12. The driving assistance device according to claim 10,
wherein a first vehicle serving as the host vehicle comprises the first image capturing device, the processor, and a display device configured to display the visible composite image,
wherein a second vehicle serving as the another vehicle comprises the second image capturing device, and
wherein in a case in which the second vehicle is stopped in a traveling lane on which the first vehicle travels, the operations comprise causing the first vehicle to:
acquire the other-produced image from the second vehicle, the other-produced image being captured by the second image capturing device; and
composite the self-produced image captured by the first image capturing device and the other-produced image acquired from the second vehicle.

13. The driving assistance device according to claim 10,
wherein a first vehicle serving as the host vehicle comprises the first image capturing device, the processor, and a display device configured to display the visible composite image,
wherein a second vehicle serving as the another vehicle comprises the second image capturing device, and
wherein in a case in which a traveling lane of the first vehicle and a traveling lane of the second vehicle merge, the operations comprise causing the first vehicle to:
acquire the other-produced image from the second vehicle, the other-produced image being captured by the second image capturing device; and
composite the self-produced image captured by the first image capturing device and the other-produced image acquired from the second vehicle.

14. The driving assistance device according to claim 10,
wherein a first vehicle serving as the host vehicle comprises the first image capturing device, the processor, and a display device configured to display the visible composite image,
wherein a second vehicle serving as the another vehicle comprises the second image capturing device,
wherein the second vehicle is at least one of vehicles including a third vehicle in front of the first vehicle in a traveling direction and a fourth vehicle in front of the first vehicle and in an oncoming direction opposing the third vehicle, and
wherein the operations comprise causing the first vehicle to:
acquire the other-produced image from the second vehicle, the other-produced image being captured by the second image capturing device; and
composite the self-produced image captured by the first image capturing device and the other-produced image acquired from the second vehicle.

15. The driving assistance device according to claim 10,
wherein a first vehicle serving as the host vehicle comprises the first image capturing device and a display device configured to display the visible composite image,
wherein a second vehicle serving as the another vehicle comprises the second image capturing device,
wherein the processor is provided in a server device capable of communicating with the host vehicle and the another vehicle,
wherein the second vehicle is at least one of vehicles including a third vehicle in front of the first vehicle in a traveling direction and a fourth vehicle in front of the first vehicle and in an oncoming direction opposing the fourth vehicle, and
wherein the operations further comprise causing the server device to:
acquire the self-produced image from the first vehicle and the other-produced image from the second vehicle, the self-produced image being captured by the first image capturing device, the other-produced image being captured by the second image capturing device;
composite the self-produced image acquired from the first vehicle and the other-produced image acquired from the second vehicle; and
transmit the visible composite image to the display device of the first vehicle.

16. The driving assistance device according to claim 10,
wherein a first vehicle serving as the host vehicle comprises the first image capturing device, the processor, and a display device configured to display the visible composite image,
wherein a second vehicle serving as the another vehicle comprises the second image capturing device, and
wherein in a case in which the first vehicle enters or exits a parking lot and the second vehicle is parked at any position in the parking lot, the operations comprise causing the first vehicle to:
acquire the other-produced image from the second vehicle, the other-produced image being captured by the second image capturing device; and
composite the self-produced image captured by the first image capturing device and the other-produced image acquired from the second vehicle.

17. The driving assistance device according to claim 1,
wherein the second image capturing device is provided separately from the moving body.

18. The driving assistance device according to claim 1,
wherein the generating the visible composite image comprises:
determining a relative position between the first image capturing device and the second image capturing device; and
compositing the plurality of images including the self-produced image and the other-produced image based on the relative position.

19. A driving assistance method in a driving assistance device for assisting driving of a moving body, the driving assistance method comprising:
acquiring a self-produced image obtained by capturing an image of a surrounding of a moving body by a first image capturing device mounted on the moving body and an other-produced image captured by a second image capturing device different from the first image capturing device; and
generating a visible composite image by compositing a plurality of images including the self-produced image and the other-produced image.

20. A non-transitory computer-readable medium storing a program that, when executed by a processor, causes a computer to execute a driving assistance method for assisting driving of a moving body, the driving assistance method comprising:
acquiring a self-produced image obtained by capturing an image of a surrounding of a moving body by a first image capturing device mounted on the moving body and an other-produced image captured by a second image capturing device different from the first image capturing device; and
generating a visible composite image by compositing a plurality of images including the self-produced image and the other-produced image.
